(19) United States
(12) Patent Application Publication
(10) Pub. No.: US 2009/0228980 A1
(43) Pub. Date: Sep. 10, 2009

(54) SYSTEM AND METHOD FOR DETECTION OF ANOMALOUS ACCESS EVENTS

(75) Inventors: Virginia Ann Zingelewicz, Scotia, NY (US); Catherine Mary Graichen, Malta, NY (US); Corey Nicholas Bufi, Troy, NY (US); Renee Ann Guhde, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/043,207

(22) Filed: Mar. 6, 2008

(51) Int. Cl. G06F 7/04

(52) U.S. Cl. 726/22

(57) ABSTRACT

A system for detecting an anomalous access event is provided. The system includes a tracking module configured to provide multiple graphical representations corresponding to a number of paths traversed by an individual at various times. The system also includes a similarity metric module configured to compare the multiple graphical representations and detect an anomalous access event.

### BACKGROUND

The invention relates generally to security systems, and more particularly to access control systems.

Typically, access control systems record events as individuals use their access control device or code to gain entry to locations within a facility. In addition to normal access events, alarms are also recorded in cases such as doors held open too long or forced open. Generally, alarms are further investigated by security officers to verify the facility remains secure. Security system alarms are typical responses to physical scenarios based on the type of devices in use. Security systems offering advanced features that analyze multiple pieces of information to determine significant events are desirable.

Furthermore, security access control software provides recording capabilities on access events and alarms. In a non-limiting example, reports that indicate individuals who presented their badge at a particular checkpoint are easily retrieved. However, data is displayed as textual information. Alarms are generally shown on display monitors with textual information about the device issuing the alarm and the type of alarm. Since most security officers are very familiar with the facility and the local terminology describing locations, providing data in formats to improve understanding may also be a significant improvement in security products.

It is therefore desirable for an improved security system.

### BRIEF DESCRIPTION

In accordance with an embodiment of the invention, a system for detecting an anomalous access event is provided. The system includes a tracking module configured to provide multiple graphical illustrations corresponding to a number of paths traversed by an individual at various times. The system also includes a similarity metric module configured to compare the plurality of graphical representations and detect an anomalous access event.

In accordance with another embodiment of the invention, a security system is provided. The security system includes multiple access control devices configured to record one or more access events. The system also includes a processor comprising a database module configured to generate a database of the access events. The processor also includes a tracking module configured to provide multiple graphical representations of a number of paths traversed by an individual at various times based upon the database. The processor also includes a similarity metric module configured to compare the multiple graphical representations and detect an anomalous access event.

In accordance with another embodiment of the invention, a method of assembling a security system is provided. The method includes providing multiple access control devices configured to record one or more access events. The method also includes providing a processor comprising a database module configured to generate a database of the access events. The method also includes providing a processor comprising a tracking module configured to provide a plurality of graphical representations of a number of paths traversed by an individual at various times based upon the database. The method further includes providing a similarity metric module configured to compare multiple graphical representations and detect an anomalous access event.

These and other advantages and features will be more readily understood from the following detailed description of preferred embodiments of the invention that is provided in connection with the accompanying drawings.

### DRAWINGS

FIG. 1 is a block diagram representation of a security system in accordance with an embodiment of the invention.

FIG. 2 is a schematic illustration of an exemplary person-path model.

FIG. 3 is a schematic illustration of another exemplary person-path model.

FIG. 4 is a flow chart representing steps in a method for assembling a security system in accordance with an embodiment of the invention.

### DETAILED DESCRIPTION

As discussed in detail below, embodiments of the invention include a system and a method for detection of anomalous events. A graphical visualization of an activity or an event of an individual within a secured facility is generated to monitor the activity and aid security personnel with security operations in the facility. Further, an analytical metric over the graphical visualization is disclosed that compares the individual's event with prior events of the individual, which may be considered as his/her normal activity. The analytical metric may also be used to compare the individual's event with that of other individuals within the facility.

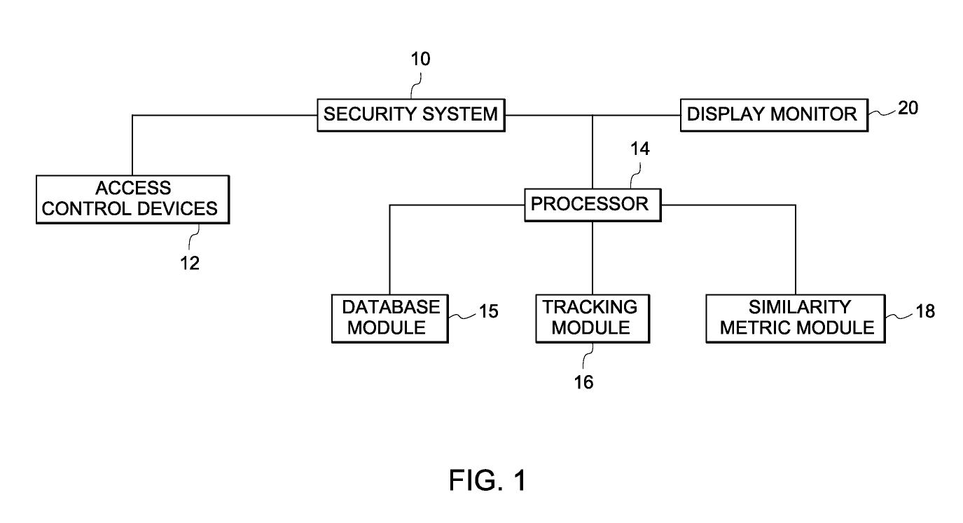

FIG. 1 is a block diagram representation of a security system 10 for detecting an anomalous access event. The security system 10 includes a number of access control devices 12 that record one or more access events. Non-limiting examples of the access control devices 12 include a badge reader, a magnetic reader, a biometric reader, a fingerprint reader, or a camera. A processor 14 includes a database module 15 that generates a database of the access events. The processor 14 also includes a tracking module 16 that provides multiple graphical representations corresponding to a number of paths traversed by an individual at various times based upon the database in the database module 14. The graphical representations may also be referred to as “person-path model”. The person-path model provides a spatial representation of access events and illustrates each individual as a network graph. In a particular embodiment, the graphical representations include a number of nodes and edges. As used herein, the term ‘nodes’ refers to events occurring at access points such as, but not limited to, an entry door or an exit door. Similarly, the term “edges” refers to successive events between the nodes or a sequence in which the individual visits the nodes. The nodes and the edges are annotated with a number of times the individual visits the node over a unit of time and a number of times the individual passes through a given set of nodes, respectively. An average time between the events is also used in the annotation. The nodes appear as a display symbol along with a unique identifier and allow security personnel to trace the individual's movements through the facility with complete knowledge of an actual location of the individual each time an event is initiated. In one embodiment, the event is initiated by a swipe of a badge reader.

To enhance security features, a similarity metric module 18 is also employed. The similarity metric module 18 compares the multiple graphical representations to generate a similarity function having a similarity score and enables detection of an anomalous access event. The similarity score ranges between 0 and 1, wherein 0 is generated for a least possible similarity in the graphical representation and 1 is generated for a most similar graphical representation. In one embodiment, the similarity metric module 18 generates a similarity function directly proportional to a number of nodes and edges that are common between the graphical representations. In another embodiment, the nodes and the edges have the same weighting to represent the frequency of the nodes and the edges being traversed. In yet another embodiment, the similarity metric module 18 adjusts a relative contribution of the nodes and the edges.

A goal in evaluating path similarity is to identify changes in a path of the individual that detects an anomalous behavior. In one embodiment, anomalies are detected utilizing a three-phased approach. First, an individual's path on a particular day is compared to his/her history. A threshold of the similarity metric is used to decide if the test path is similar to the historical data. If the similarity is above the threshold, then no anomaly exists. If dissimilarity is detected, then a second step is taken including selecting historical paths from other individuals that are similar to the individual's historical paths. Finally, a check is performed to verify if the paths traversed by other individuals also showed a deviation from their historical paths at a similar time to the test individual (for example on the particular day).

Several parameters such as, but not limited to, frequency of a path being taken, and a time of the day access events occur, may be used to tune the similarity metric module 18. Access events that occur at roughly a same time of the day are considered more similar than a same event occurring at different times of the day. In a particular embodiment, the similarity metric module 18 compares multiple graphical representations of a particular individual traversed on different days. In another embodiment, the similarity metric module 18 compares multiple graphical representations of different individuals traversed at a common time. In yet another embodiment, the similarity metric module 18 compares a graphical representation of an individual on a day of a week with one or more graphical representations of the individual on a different day of the week. In another embodiment, the similarity metric module compares a graphical representation of an individual on a weekend day with one or more graphical representations of the individual on a different weekend day.

In one embodiment, the similarity metric module adds a penalty to the similarity score that is proportional to a difference between time of an access event of an individual at a location and an average time of the access event of the individual at the location derived from a database of the graphical representations. In another embodiment, the similarity metric module adds a penalty to the similarity score that is proportional to a difference between time of an access event of an individual at a location and at least one of a minimum or a maximum of a time of the access event of the individual at the location derived from a database of the graphical representations. In yet another embodiment, the similarity metric module is configured to integrate a standard deviation of a time of an access event of the individual at a location based upon the graphical representations. A display monitor 20 is used to display the graphical representations.

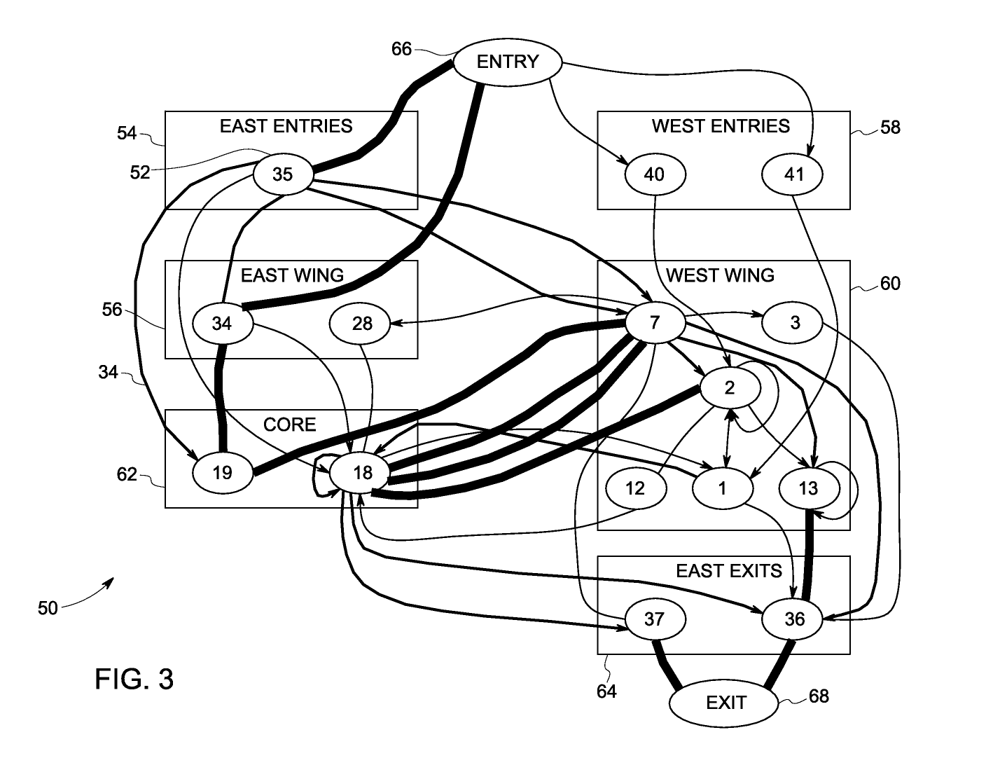

In one embodiment, selected nodes may be weighted more heavily in the similarity metric than others. This weighting may be dependent on additional information stored in the security system database. For instance, specific entrances and exits to a building may not be significant to determining anomalies. In an alternate embodiment, groups of nodes may be treated as a “super” node. For instance, two entrances side-by-side may be used interchangeably. The security system will capture which entrance is used when an individual utilizes the specific access control device, but for anomaly detection they can be considered equivalent. In such a case, the similarity metric can add the frequencies from the two nodes. The edges would also be redefined to connect events to and from this new super node instead of the individual nodes. For instance in FIG. 3, the West Entries nodes 58 could be combined into a new single node for purposes of the similarity metric evaluation and anomaly detection. The edges entering that would be combined to a single edge since they share a common source. However, the edges leaving would remain separate since they do not share a common destination. In another embodiment, modules 15, 16, and 18 may be placed on multiple processors 14.

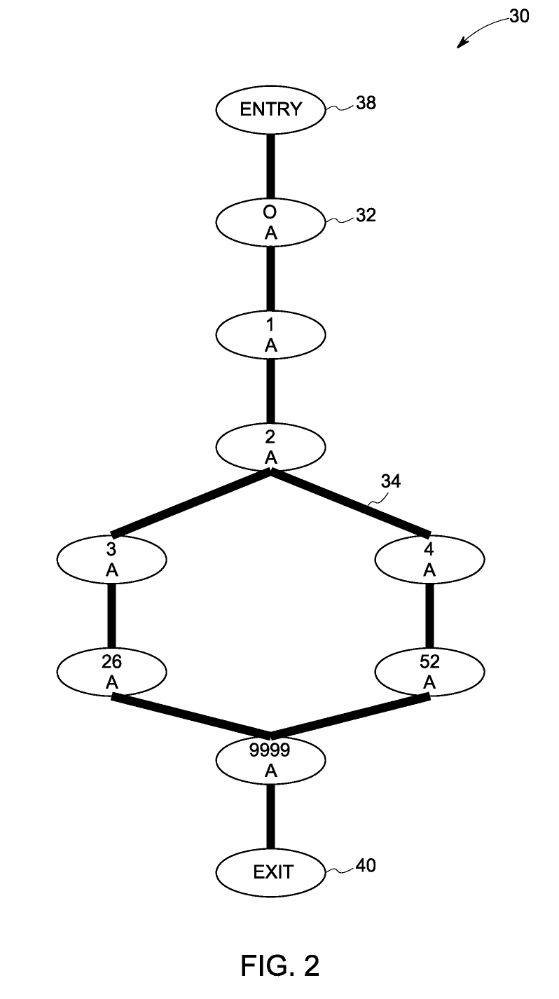

FIG. 2 is an illustration of an exemplary graphical representation 30. The graphical representation 30 includes access events for an individual on site. A node 32 represents an event in the access control security system. Typically, these events are readings from an access control device such as a badge reader. An edge 34 represents a temporal sequence between the events represented by nodes 32. Thickness of the edges 34 may be increased to indicate a relative higher frequency. A node 38 represents an entry point and a node 40 represents an exit point. The entry point 38 is used to start path sequences. The node connected to entry point 38 represents the first event in a particular path, such as a badge read of an individual entering a facility. The exit point 40 represents the end of a path. The node connected to exit point 40 represents the last event prior to the individual leaving the facility. In some embodiments, this represents a badge read that allows an individual to exit the building.

FIG. 3 is another exemplary graphical representation 50 including local groupings of nodes 52. The nodes 52 are classified based upon a location, such as East entries 54, East wing 56, West entries 58, West wing 60, Core 62 and East exit 64. Such groupings are determined by additional information stored in the security system such as floor, wing, zone, building, site, etc. Similarly, the edges 34, as referenced in FIG. 2, represent the temporal sequence between the events represented by the nodes 52. The nodes 66 and 68 represent an entry point and an exit point respectively.

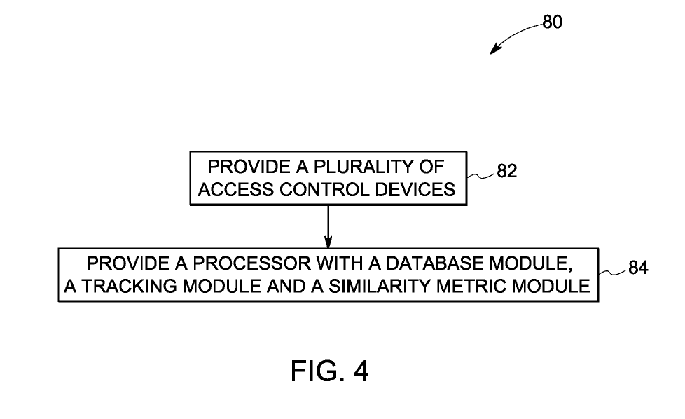

FIG. 4 is a flow chart representing steps in an exemplary method 80 for assembling a security system. The method 80 includes providing multiple access control devices to record one or more access events in step 82. In a particular embodiment, a badge reader is provided. In another embodiment, a magnetic reader, a biometric reader or a fingerprint reader may be provided. In yet another embodiment, a camera is provided. In another embodiment, a combination of two or more of the foregoing access control devices is provided. A processor including a database module, a tracking module, and a similarity metric module is provided in step 84. The database module generates a database of the access events. The tracking module provides multiple graphical representations of a number of paths traversed by an individual at various times based upon the database. Further, the similarity metric module compares the multiple graphical representations and detects an anomalous access event. In one embodiment, the processor with the similarity metric module generating a similarity function directly proportional to a number of nodes and edges that are common between graphical representations is provided.

It should be clear to one skilled in the art, that the similarity metric module evaluates an underlying data structure defining the nodes and edges (events and sequences of events) (as in graph theory) and not the illustration of that graphical representation as shown in FIG. 2 and FIG. 3. As such the nodes and edges of the structure may have several annotations or fields added to them, including, but not limited to, frequency of occurrence, time of day, day of week, and priority as examples.

The various embodiments of a system and method for detecting anomalous events described above thus provide a convenient and efficient means to prevent security incidents from occurring. Monitoring of real time, predictive behavior of individuals within a site increases safety and efficiency of the sites, and reduces a number of tedious and expensive event investigations. The person-path model and the similarity metric module described above facilitate efficient exploratory search over alarm situations, while efficiently distinguishing between true and false alarms.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a biometric reader with respect to one embodiment can be adapted for use with a similarity metric module configured to compare a graphical representation of an individual on a weekend day with one or more graphical representations of the individual on a different weekend day. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for detecting an anomalous access event, comprising:
a tracking module configured to provide a plurality of graphical representations corresponding to a number of paths traversed by an individual at various times; and
a similarity metric module configured to compare the plurality of graphical representations and detect the anomalous access event.

2. The system of claim 1, wherein the graphical representations comprise a number of nodes representing events captured by the system and a number of edges representing the sequence of the event occurrences.

3. The system of claim 2, wherein the similarity metric module is configured to generate a similarity function directly proportional to a number of nodes and edges that are common between the graphical representations.

4. The system of claim 1, wherein the similarity metric module is configured to compare the plurality of graphical representations of a particular individual traversed on different days.

5. The system of claim 1, wherein the similarity metric module is configured to compare the plurality of graphical representations of different individuals traversed at a common period of time.

6. The system of claim 1, wherein the similarity metric module is configured to compare the graphical representation of an individual on a day of the week with one or more graphical representations of the individual on a different day of the week.

7. The system of claim 1, wherein the similarity metric module is configured to add a penalty to a similarity score, proportional to a difference between time of day of an access event of an individual at a location and an average time of day of the access event of the individual at the location derived from a database of the graphical representations.

8. The system of claim 1, wherein the similarity metric module is configured to add a penalty to a similarity score, proportional to a difference between time of day of an access event of an individual at a location and at least one of a minimum or a maximum of a time of day of the access event of the individual at the location derived from a database of the graphical representations.

9. The system of claim 1, wherein the similarity metric module is configured to integrate a standard deviation of a time of day of an access event of an individual at a location based upon the graphical representations.

10. The system of claim 2, wherein the graphical representations comprise a combination of the nodes into a single node via the tracking module based upon a configuration information from the system.

11. The system of claim 2, wherein the nodes and the edges comprise a plurality of importance weightages applied based upon a configuration information from the system.

12. The system of claim 7, wherein the similarity score from the similarity metric module is compared against a similarity threshold to detect the anomalous acces event.

13. The system of claim 1, wherein the similarity metric module is further configured to compare each of the graphical representations of the individual via a plurality of algorithms to detect the anomalous access event.

14. The system of claim 13, wherein the algorithms comprise comparing the graphical representation from a single day, graphical representations from multiple days, and graphical representations from related groups of other individuals.

15. A security system, comprising:
a plurality of access control devices configured to record one or more access events;
at least one processor comprising:
a database module configured to generate a database of the access events;
a tracking module configured to provide a plurality of graphical representations of a number of paths traversed by an individual at various times based upon the database; and
a similarity metric module configured to compare the plurality of graphical representations and detect an anomalous access event.

16. The security system of claim 15, wherein the access control devices comprise a badge reader, a magnetic card reader, a biometric reader, a fingerprint reader, or a camera.

17. The security system of claim 15, wherein the graphical representations comprise a number of nodes representing events captured by the security system and edges representing the sequence of the event occurrences.

18. The security system of claim 17, wherein the similarity metric module is configured to generate a similarity function directly proportional to the number of nodes and edges that are common between the graphical representations.

19. The security system of claim 15, comprising a display monitor configured to display the graphical representations.

20. A method of assembling a security system comprising:
providing a plurality of access control devices configured to record one or more access events; and
providing at least one processor comprising:
a database module configured to generate a database of the access events;
a tracking module configured to provide a plurality of graphical representations of a number of paths traversed by an individual at various times based upon the database; and
a similarity metric module configured to compare the plurality of graphical representations and detect an anomalous access event.

21. The method of claim 20, wherein said providing a plurality of access control devices comprises providing one or more of a badge reader, a magnetic card reader, a biometric reader, a fingerprint reader, a camera, or combinations of two or more of the foregoing.

22. The method of claim 20, wherein said providing a processor comprises providing the processor with the similarity metric module configured to generate a similarity function directly proportional to a number of nodes and edges that are common between the graphical representations.

23. The method of claim 20, wherein said providing a processor comprises providing the similarity metric module configured to compare the plurality of graphical representations, the graphical representations comprising a number of nodes and edges.

24. The method of claim 23, wherein said providing a processor comprises providing the similarity metric module configured to generate a similarity function directly proportional to the number of nodes and edges that are common between the graphical representations.
